(19) United States
(12) Patent Application Publication
(10) Pub. No.: US 2011/0181164 A1
(43) Pub. Date: Jul. 28, 2011

(54) LED LAMP FOR WIDE AREA LIGHTING

(76) Inventor: Chiu-Min LIN, Guishan Township (TW)

(21) Appl. No.: 12/691,972

(22) Filed: Jan. 22, 2010

(51) Int. Cl. H01J 61/52; H01J 5/48

(52) U.S. Cl. 313/46; 313/318.01

(57) ABSTRACT

An LED lamp with improved lighting area has a lamp base, a substrate assembly mounted on the lamp base and a cap engaged with the lamp base to enclose the substrate assembly therein. The substrate assembly has multiple substrates intersecting each other. Multiple LEDs are mounted on the substrates to form a spherical distribution that allows the LED lamp to provide wide-angled lighting.

### BACKGROUND OF THE INVENTION

1. Field of the Invention

The present invention relates to a Light-emitting diode (LED) lamp, especially to an LED lamp having multiple LEDs arranged in a spherical configuration to provide wide-angled lighting.

2. Description of the Related Art

Although LED-based light bulbs consume lower power than fluorescent lamps, the applications of the LED bulbs are limited due to thermal dissipation problems. As temperature rises, efficiency and life time of the LEDs will reduce. Furthermore, the LEDs of the conventional LED bulb emit light toward a direction and only illuminate a small area. For some applications requiring wide area lighting, the conventional LED bulbs cannot provide the needed lighting effect.

To overcome the shortcomings, the present invention provides an LED lamp for wide area lighting to mitigate or obviate the aforementioned problems.

### SUMMARY OF THE INVENTION

The main objective of the invention is to provide an LED lamp for wide area lighting, wherein multiple LEDs of the LED lamp are distributed in a spherical configuration to increase illuminating area and the heat generated by the LEDs can be dissipated to ensure lighting efficiency.

To achieve the objective, an LED lamp of the present invention has a lamp base, a substrate assembly mounted on the lamp base and a cap engaged with the lamp base to enclose the substrate assembly therein. The substrate assembly has multiple substrates intersecting each other. Multiple LEDs are mounted on the substrates to form a spherical distribution that allows the LED lamp to provide a substantial directionless and wide-angled lighting.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of an LED lamp in accordance with the present invention; and

FIG. 2 is another exploded perspective view of the LED lamp in accordance with the present invention;

FIGS. 3A to 3D are plan views of different substrates mounted in the LED lamp in accordance with the present invention; and

FIG. 4 is a cross sectional view of a part of the LED lamp in accordance with the present invention.

### DETAILED DESCRIPTION OF THE PREFERRED EMBODIMENTS

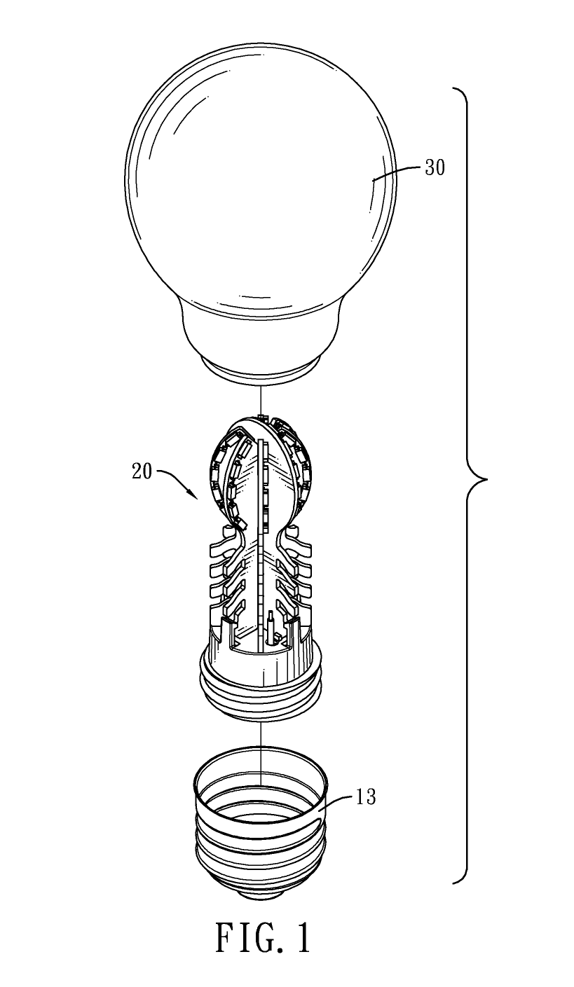

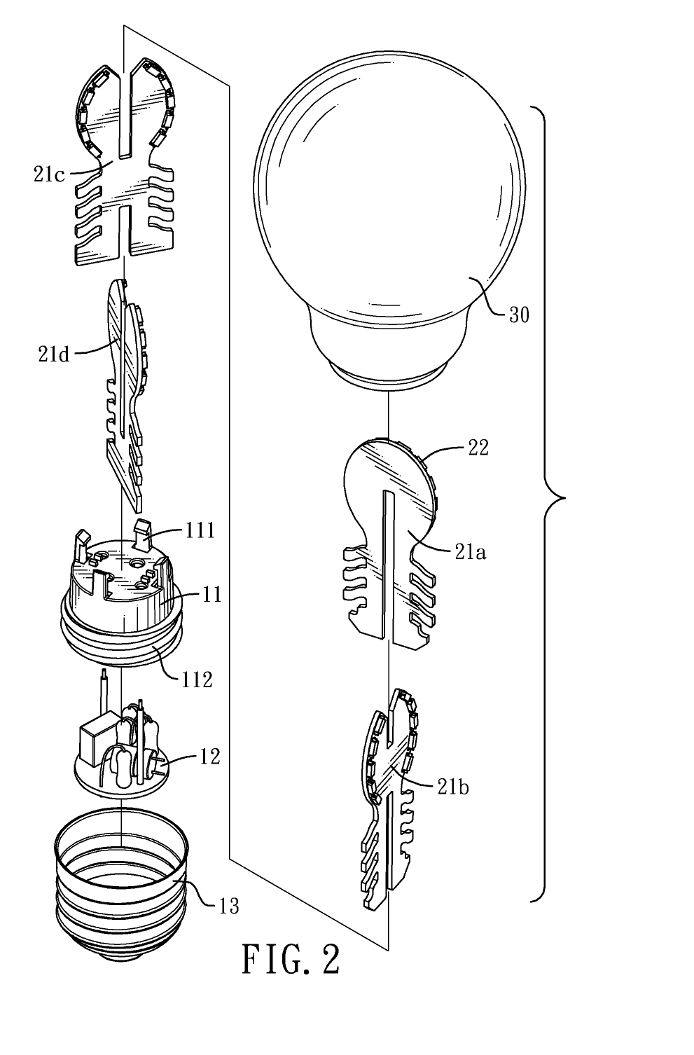

With reference to FIGS. 1 and 2, an LED lamp in accordance with the present invention comprises a lamp base, a substrate assembly (20) and a cap (30).

The lamp base comprises a mounting base (11), a circuit module (12) and an outer contact (13). The mounting base (11) includes a top surface, a bottom surface, multiple hooks (111) and a hollow threaded plug (112). The hooks (111) protrude upwardly from the top surface of the mounting base (11). The threaded plug (112) is formed on and protrude downwardly from the bottom surface of the mounting base (11). The circuit module (12) is held in the hollow threaded plug (112). The outer contact (13) is correspondingly screwded to the threaded plug (112).

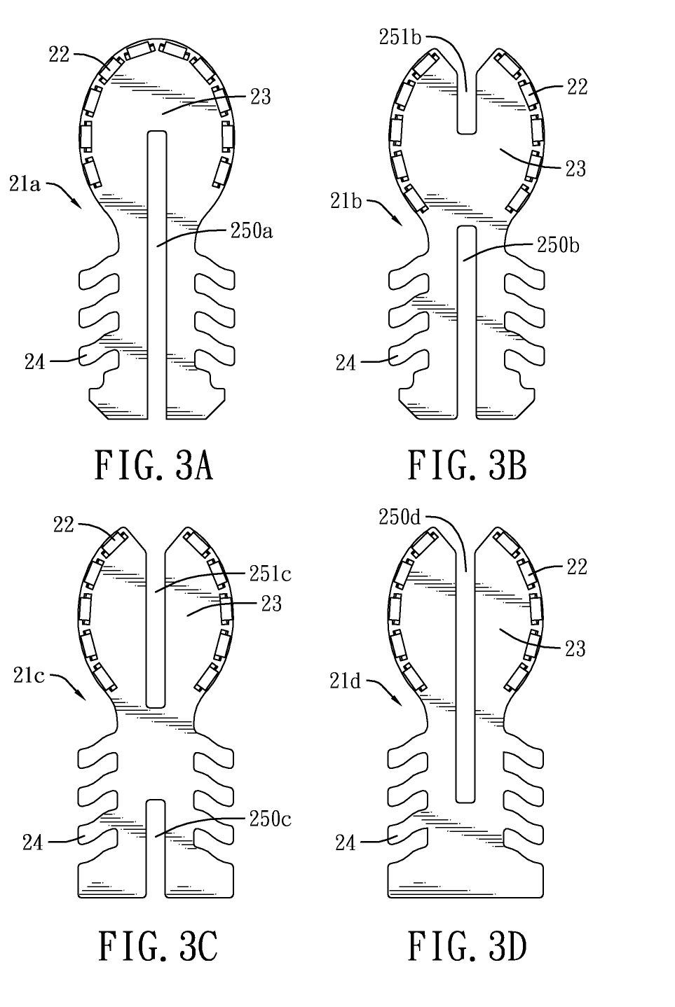

With further reference to FIGS. 3A to 3D, the substrate assembly (20) comprises multiple substrates (21a-21d) and multiple light emitting diodes (LEDs)(22) mounted on the substrates (21a-21d). Each of the substrates (21a-21d) is a racket-shaped substrate and has a high thermal conductivity in the embodiment. Each substrate (21a-21d) has a substantial elliptical upper portion as an LED mounting area (23) and a substantial elongated lower portion integrally extending from the elliptical upper portion. The LEDs (22) are preferably arranged on the same surface of the substrate (21a-21d) around a periphery of the LED mounting area (23). Each substrate (21a-21d) further has multiple fins (24) protruding symmetrically from opposite edges of the elongated lower portion.

The first substrate (21a) has one slot (250a) that extends lengthwise from a bottom edge of the elongated lower portion to the LED mounting area (23).

The second substrate (21b) further has a lower slot (250b) and an upper slot (251b) that extend from the bottom edge of the elongated lower portion and from a top edge of the LED mounting area (23) respectively, wherein the lower slot (250b) is longer than the upper slot (251b) in length.

The third substrate (21c) also has a lower slot (250c) and an upper slot (251c) that extend from the bottom edge of the elongated lower portion and from the top edge of the LED mounting area (23) respectively and toward each other, wherein the lower slot (250c) is shorter than the upper slot (251c) in length.

The fourth substrate (21d) has one slot (250d) extending from the top edge of the LED mounting area (23).

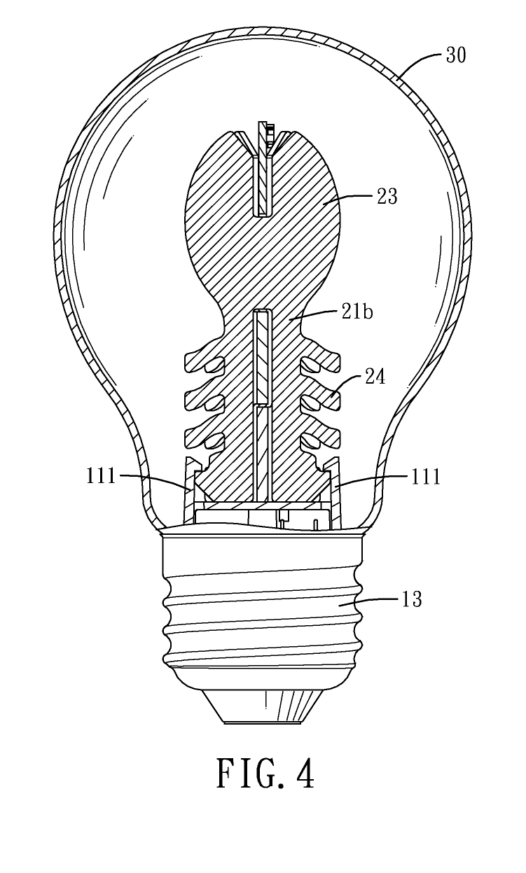

With further reference to FIG. 4, the four substrates (21a-21d) are intersected and engaged together with the slots (25a-25d) to form a substantially cylindrical assembly. The LEDs (22) are controlled by the circuit module (12) and mounted on the LED mounting areas (23) of the assembled substrates (21a-21d) to form a substantial spherical distribution, thereby accomplishing directionless lighting. In this embodiment, the bottom edges of the first and second substrates (21a, 21b) are engaged with the hooks (111) to securely attach the assembled substrates (21a-21d) to the mounting base (11).

The cap (30) is substantially bulb-shaped and mounted on the lamp base to enclose the substrate assembly (20) therein. Preferably, the cap (30) is transparent to allow the LEDs (22) to emit light outward.

In short, the heat generated by the LED can be conducted to the substrates and dissipated quickly. Since each substrate has a relative large area and multiple fins, the thermal dissipation efficiency can be improved. Furthermore, the spherical distribution of the LEDs allows the LED lamp to provide a substantial directionless lighting, thereby illuminating a relative larger area.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An LED lamp for wide area lighting comprising:
a lamp base;
a substrate assembly mounted on the lamp base and comprising multiple substrates, each of the substrates having multiple light emitting diodes (LEDs) mounted on the same surface of the substrate, the LEDs on the multiple substrates forming a substantial spherical distribution;
a cap engaged with the lamp base to enclose the substrate assembly.

2. The LED lamp as claimed in claim 1, wherein each of the substrates has an upper portion as an LED mounting area and a lower portion integrally extending from the LED mounting area, and the LEDs are mounted around a periphery of the LED mounting area.

3. The LED lamp as claimed in claim 2, wherein each of the substrates further comprises multiple fins extending from opposite edges of the elongated lower portion.

4. The LED lamp as claimed in claim 2, wherein the upper portion of each substrate is substantially elliptical, and the lower portion of each substrate is substantially elongated.

5. The LED lamp as claimed in claim 3, wherein the upper portion of each substrate is substantially elliptical, and the lower portion of each substrate is substantially elongated.

6. The LED lamp as claimed in claim 1, wherein each of the substrates has at least one slot, and the substrates are intersected via the slots.

7. The LED lamp as claimed in claim 2, the substrate assembly comprising a first substrate, a second substrate, a third substrate and a fourth substrate, wherein
the first substrate has a slot extending from a bottom edge of the lower portion to the LED mounting area of the first substrate;
the second substrate has a lower slot and an upper slot that extend toward each other, the lower slot extends from a bottom edge of the lower portion of the second substrate, and the upper slot is shorter than the upper slot and extends from a top edge of the LED mounting area of the second substrate;
the third substrate has a lower slot and an upper slot that extend toward each other, the lower slot extends from a bottom edge of the lower portion of the third substrate, and the upper slot is longer than the lower slot and extends from a top edge of the LED mounting area of the third substrate; and
the fourth substrate has a slot extending from a top edge of the LED mounting area to the lower portion of the fourth substrate.

8. The LED lamp as claimed in claim 1, wherein the lamp base comprises:
a mounting base having a top surface, a bottom surface, multiple hooks protruding upwardly from the top surface and a hollow threaded plug formed on and protruding downwardly from the bottom surface;
a circuit module mounted in the threaded plug of the mounting base; and
an outer contact screwed to the threaded plug of the mounting base.

9. The LED lamp as claimed in claim 2, wherein the lamp base comprises:
a mounting base having a top surface, a bottom surface, multiple hooks protruding upwardly from the top surface and a hollow threaded plug formed on and protruding downwardly from the bottom surface;
a circuit module mounted in the threaded plug of the mounting base; and
an outer contact screwed to the threaded plug of the mounting base.

10. The LED lamp as claimed in claim 7, wherein the lamp base comprises:
a mounting base having a top surface, a bottom surface, multiple hooks protruding upwardly from the top surface and a hollow threaded plug formed on and protruding downwardly from the bottom surface;
a circuit module mounted in the threaded plug of the mounting base; and
an outer contact screwed to the threaded plug of the mounting base.
